(19) United States
(12) Patent Application Publication
(10) Pub. No.: US 2012/0171452 A1
(43) Pub. Date: Jul. 5, 2012

(54) DEVICE AND METHOD FOR PRODUCING THICK-WALLED MOULDED PLASTICS PARTS HAVING REDUCED SHRINKAGE SITES BY INJECTION MOLDING OR EMBOSSING

(75) Inventors: Arne Schmidt, Darmstadt (DE); Marc Poth, Reinheim (DE); Christian Eberle, Griesheim (DE); Werner Hoess, Hanau (DE)

(73) Assignee: Evonik Roehm GmbH, Darmstadt (DE)

(21) Appl. No.: 13/375,843

(22) PCT Filed: May 25, 2010
(86) PCT No.: PCT/EP2010/057097

§ 371 Date: Dec. 2, 2011

(30) Foreign Application Priority Data
Jul. 13, 2009 (DE) 102009027646.7

(51) Int. Cl. B32B 27/30; B29C 45/73; B29C 45/76

(52) U.S. Cl. 428/220; 425/144; 264/40.1

(57) ABSTRACT

The invention relates to a device and method for producing thick-walled plastic molded parts by injection molding or embossing. The device comprises a mold for injection molding or embossing, having a cavity, and is characterized in that the mold comprises a wall region adjacent to the cavity, and a body removed from the cavity and adjacent to the wall region near the cavity, wherein the body of the mold is designed for a temperature T₁ and the wall region is designed for a temperature T₂ different from the temperature T₁. According to the method, the temperature T₂ of the wall region of the mold near the cavity is brought to and held at a value greater than the Vicat temperature Tᵥ of the plastic molding mass before and/or during the injection process, wherein the temperature T₂ is greater than the temperature T₁ of the mold body, and the temperature T₂ of the wall region near the cavity is brought to a temperature below the Vicat temperature Tᵥ of the plastic molding mass during the solidification of the plastic molding mass. The result is thick-walled molded plastic parts, such as optical lenses and the like, having reduced shrinkage sites.

The invention relates to a device and a method for producing thick-walled moulded plastics parts by means of injection-moulding or injection-compression-moulding processes, the resultant moulded plastics parts having a reduced number of so-called sink marks, or less pronounced sink marks, in comparison with conventional devices and methods.

In particular, the invention relates to a device and a method for producing moulded plastics parts with wall thicknesses of more than 3 mm, expediently more than 5 mm, particularly expediently more than 8 mm, the moulded plastics parts being obtained by the injection-moulding process or being injection-compression-moulded from thermoplastic moulding compounds, preferably PMMA.

Thick-walled moulded plastics parts of this kind are, for example, plastic lenses for spectacles. Thermosetting casting compounds (CR39) and thermoplastic moulding compounds are generally employed here, with polystyrene, polymethylmethacrylate, polymethylmethacrylic imide, cyclo-olefin copolymers, polycarbonate or co-polycarbonate being used according to the application.

In the case of known methods, lens blanks of uniform wall thickness are produced in cycle times of below 30 s and a standard injection-moulding process is normally used for this. The moulding compound is introduced into the cavity of the mould in the filling phase via channels of small dimensions. Because amorphous polymers undergo a high density reduction in the cooling phase, in the range of up to 10 percent by volume or more, this material shrinkage is compensated in a subsequent follow-up pressure phase by plastic melt being fed in by the injection plunger of the injection-moulding device.

In the case of a standard injection-compression moulding process, as a difference from the standard injection-moulding process, in a first filling phase the plastics compound is introduced into a pre-enlarged cavity, and this plastics moulding compound is subsequently compressed by means of an axial compression of the mould. The mass that is introduced into the pre-enlarged cavity in the first filling phase corresponds in this case to the mass of the parts that are later removed. The axial movement of the mould has the effect of reducing the size of the pre-enlarged cavity and of bringing about the remaining filling of the cavity. The standard injection-compression-moulding process is used for simple optical parts in order to avoid sink marks as a consequence of material shrinkage.

In addition, however, surface markings may also occur because the plastics moulding compound cannot flow into the cavity in an optimal laminar flow. Cold outer layers may become displaced in the filling phase. By increasing the temperature of the mould up to almost the glass transition point, the occurrence of cold outer layers is suppressed. However, this results in a longer cycle time.

In order to ensure a virtually optimal laminar flow, large sub-gates are required, and these have to be subsequently cut off without creating any dust and generally can no longer be used for producing optical parts.

Nevertheless, the problem of avoiding so-called “sink marks” assumes quite central significance in the production of thick-walled moulded plastics parts, for example optical lenses from thermoplastic moulding compounds, by means of injection-moulding or injection-compression-moulding techniques, such as for instance closing compression moulding, expansion compression moulding or sequential compression moulding. Thick-walled moulded parts are usually such moulded parts that have a wall thickness of at least three millimetres at least one point. In particular in the case of moulded part thicknesses of five millimetres, eight millimetres or thicker, “sunken marks” can be seen after cooling and demoulding. These are generally marks on the finished moulded body at which the increased free shrinkage (volume reduction) of the material leads to defects with inadequate material thickness. Although this phenomenon can in theory be countered by increasing the follow-up pressure of the screw, an increased follow-up pressure of the screw results in additional stressing of the thermoplastic material and may possibly lead to a molecular orientation in the moulded part. Specifically in the case of moulded parts such as lenses for optical applications, however, this is very disadvantageous, since the optical quality of the moulded part deteriorates as a result.

A method for shaping moulded plastics parts with compensation for the volume reduction of the material is known from DE 199 13 525 A1=document 1 or D1. According to D1, it discloses a method in which the curing- or cooling-induced volume reduction of the material under pressure in the cavity is compensated by a reversible expansion of the mould cavity that is dependent on the pressure inside the cavity. This is achieved, for example, by providing systems for generating a compression-pressure-dependent counterforce in the form of flexible elements introduced into the cavity. Although such a procedure appears to be suitable in individual cases for reducing shrinkage, it is complex and has not so far become established practice for injection moulding or injection-compression moulding.

A further proposal for producing thick-walled moulded parts can be taken from DE 100 48 861 A1=document 2 or D2. D2 describes a method and a device for producing thick-walled blanks for optical lenses in which a two-stage approach is adopted. In a first stage, firstly a thin lens is produced by injection moulding and this is then increased to its final thickness, i.e. “inflated”, in the second stage of production by supplying plastics material. Although the surface quality of thick-walled moulded parts can in this way be made to approach the quality of thin-walled moulded parts, according to D2 an additional compression phase is required after the first phase or even the second phase. This gives rise to the problem of molecular orientation during the follow-up pressure phase.

A method for making the shrinkage behaviour of an injection-moulded part more uniform, both between individual cavities of a multi-cavity mould and from cycle to cycle of an injection-moulding operation, is known from DE 101 14 228 A1=document 3 or D3. In this case, the temperature and/or the internal pressure in the cavity is monitored and adapted to a reference curve by temperature control of the mould from the end of the filling phase or from a pressure maximum in the cavity to the end of the injection-moulding phase.

WO 2004/058476 A3=document 4 or D4 discloses a method for regulating the production of injection-moulded parts. According to the proposal of D4, the temperature of the mould is regulated. Furthermore, the cavity and/or the mould core is directly heated or cooled. The basic concept of D4 is not to regulate the temperature of a cavity or a mould core (=compression ram) exclusively by means of a cooling circuit but with the aid of heating elements. If it is found that the cavity or mould core has a temperature that is too low, the heating elements are adjusted to a higher setting. If the temperature in the cavity or at the mould core is too high, the circulation in the cooling circuit is increased. The aim is in each case to keep the pressure and temperature conditions in the cavity constant.

Nevertheless, the regulating of the mould temperature in the injection-moulding operation that is proposed according to D3 and D4 could be improved. According to D3 and D4, the temperature regulation appears to have a relatively slow response. In addition, the temperature of the entire cavity always has to be controlled, which not only leads to a slow response, with an adverse effect on the cycle times, but also leads to increased expenditure of energy.

In the light of the prior art cited and discussed here, it has been an object of the invention to provide a device for producing thick-walled moulded plastics parts by means of injection-moulding or injection-compression-moulding processes which is of a simple construction.

Another object of the invention has been to provide a device which allows the production of moulded plastics parts, preferably from thermoplastic materials, with relatively high optical quality as far as possible by simple means but nevertheless very variably.

Yet another object of the invention has been to provide a device for producing thick-walled moulded parts which makes it possible to reduce the cycle times during the injection moulding or injection-compression moulding.

Furthermore, the reduced cycle time should not be at the expense of a follow-up pressure phase or a longer follow-up pressure phase.

A further object of the invention may be seen in the provision of a method for producing thick-walled moulded plastics parts by means of injection-moulding or injection-compression moulding processes, it being intended for the method to make the production of plastics bodies possible quickly, reliably and cost-effectively by simple means.

In terms of the method, there has likewise been the object of making the injection moulding or injection-compression moulding occur in such a way that the resultant moulded plastics parts have a reduced number of so-called sink marks, or less pronounced sink marks, in comparison with conventional devices and methods.

These objects and further objects, which although not specifically mentioned as such readily follow from the introductory discussion of the prior art or become self-evident, are achieved by a device with all the features of Claim 1.

Advantageous refinements of the device according to the invention are the subject of the claims referring back to the independent device claim.

In terms of the method, the features of the independent method claim provide a solution to the problem addressed by the invention with regard to the aspects of the method. Advantageous variants of the method are afforded protection in the method claims that are dependent on the independent method claim.

Finally, the claims of the use category protect the use of the method of the invention.

In particular because a device for producing thick-walled moulded plastics parts by injection moulding or injection-compression moulding, comprising a mould for injection moulding or injection-compression moulding with a cavity,

is distinguished

by the fact that the mould comprises a wall region which is adjacent to the cavity and a body which is remote from the cavity and adjacent to the wall region that is near the cavity,

the body of the mould being formed such that it can be controlled to a temperature T₁ and the wall region being formed such that it can be controlled to a temperature T₂, which is different from the temperature T₁,

the known devices can be successfully improved, the production of thick-walled moulded plastics parts can be successfully made more efficient and all the requirements specified by the standards institutes and industrial processors with respect to the physical and chemical properties of the resultant moulded bodies can be successfully satisfied in an outstanding way. In particular, the resultant moulded bodies have a greatly reduced number of sink marks and/or much less pronounced sink marks in comparison with moulded bodies that can be obtained by using known devices. Moreover, it is possible according to the invention to realize a great number of additional advantages.

These include:
Shortened cycle times by means of optimal process temperatures in the injection moulding or injection-compression moulding.
Optimal process temperatures with respect to the shrinkage conditions in the moulded part.
In the case of moulded parts with differences in wall thickness, the advantageous effect of the method is evident in particular with respect to the thicker wall regions of the moulded part.
Equally acting pressure distribution or compressing pressure distribution and, as a result, avoidance or reduction of sink marks on the moulded part.
Less or no molecular orientation, whereby the optical quality of lenses, for example, is improved.
Outstanding dimensional accuracy of the moulded parts.
Longer and more effective compression phase, since no prematurely frozen-in outer layers occur.

The device of the invention for producing thick-walled moulded plastics parts by injection moulding or injection-compression moulding comprises a mould for injection-moulding or injection-compression moulding with a cavity.

The term “mould for injection-moulding or injection-compression moulding” is to be understood as being synonymous with the expressions “injection mould” and “injection-compression mould”. Unless especially indicated, the term “mould” is understood hereafter as always meaning cumulatively an injection mould and an injection-compression mould. These terms are to a great extent known to a person skilled in the art.

The mould of the device according to the invention has a cavity. This is understood within the scope of the invention as meaning a hollow space which is filled with thermoplastic material during the injection-moulding or injection-compression-moulding process. It is clear that the invention is not restricted to moulds with a single cavity. Devices with moulds which have more than one cavity, whether in one or more parting planes, are equally included by the invention.

For the purposes of the invention, a mould is distinguished, inter alia, by the fact that it comprises a wall region which is adjacent to the cavity and a body which is remote from the cavity and adjacent to the wall region that is near the cavity.

At the same time, the mould encloses one or more cavities and, considered from a cavity, the region of the mould which adjoins the cavity and delimits it is referred to as the region near the cavity of the mould. Furthermore, the region of the mould which, considered from the direction of the cavity, is remote from the cavity and adjoins the wall region near the cavity of the mould is known as the body or the body remote from the cavity of the mould. The thickness of the wall region near the cavity of the mould may vary over a wide range. Similarly, the thickness of the body remote from the cavity of the mould may vary over a wide range. Generally, the ratio of the thickness of the wall region near the cavity of the mould to the thickness of the region remote from the cavity of the mould lies in the range from 1:100 to 2:1. This ratio may be constant for a mould. There may, however, be different thickness ratios for a mould considered at a number of points, depending on the specific construction of the mould and the particular process requirements for the mould.

It has proven to be advantageous within the scope of the invention if the thickness of the wall region near the cavity of the mould is equal to or less than the thickness of the body remote from the cavity of the mould. It is of particular advantage if the thickness of the wall region near the cavity is made as small as possible in comparison with the body remote from the cavity. Thus, values in the range not greater than 1:2, even more expediently not greater than 1:5 and particularly expediently not greater than 1:10, have proven to be particularly successful for the ratio of the thickness of the wall region near the cavity to the body remote from the cavity of the mould. In the case of particularly preferred devices according to the invention, the said ratio lies in the range from 1:8 to 1:2, even more preferred in the range from 1:10 to 1:5 and even more expediently in the range from 1:20 to 1:10.

With respect to the total thickness of the mould, the thickness of the wall region near the cavity of the mould may likewise extend over a wide range.

In a preferred embodiment, the device of the invention is characterized in that the thickness of the wall region makes up between approximately 1/20 and ¼ of the total thickness of the mould comprising the body remote from the cavity and the wall region near the cavity.

It is preferred even more for the device if the thickness of the wall region is approximately 1/10 to ⅕ of the total thickness of the mould comprising the body remote from the cavity and the wall region near the cavity.

The device according to the invention is characterized in particular in that the body of the mould is formed such that it can be controlled to a temperature T₁ and the wall region is formed such that it can be controlled to a temperature T₂, which is different from the temperature T₁. This refinement advantageously makes it possible for the wall region and the body of the mould to be controlled to different temperatures, and for this to be done in a very short time. The relatively slow response with respect to changes in temperature of the mould body as a whole that has previously been observed in practice can be improved significantly by isolating the wall regions near the cavity of the mould from the remaining body of the mould with a view to being about to control their temperature separately. This results particularly advantageously in the possibility of setting higher temperatures in the region near the cavity of the mould, with the consequence that the heat ultimately acting on the plastics material introduced into the cavity brings about a higher temperature of the plastics material. Similarly, the isolation of the wall region from the remaining body of the mould with regard to temperature controllability brings about the possibility that the temperature of the outer regions near the cavity of the mould can be controlled for a longer time period than is the case with conventional devices, with the result that the number of sink marks or how pronounced they are, that is to say the intensity of the sink marks, is reduced in comparison with conventional devices.

The wall region near the cavity of the mould and the remaining body can be isolated from one another with a view to temperature controllability in various ways. It may be possible to provide the regions near the cavity of the mould with a special coating, which can for example be activated by means of resistance heaters or inductively. In this respect, a person skilled in the art may succeed in using coating materials that are known per se, such as for instance thermoceramic coatings. However, the subsequent coating of existing moulds is rather laborious.

It may therefore be preferred for the purposes of the invention that the wall region near the cavity of the mould and the body remote from the cavity of the mould have temperature control circuits that are separate from one another. In this way, the differences in temperature between the wall region of the mould and the remaining body of the mould can be realized in a quick, simple and expedient manner.

The activation of the two temperature control circuits may take place in various ways. Apart from the already mentioned activation by means of resistance heaters or inductive activation, it is possible to regulate the temperature by means of liquid media, such as for example water, oil or steam.

It has been found to be particularly advantageous in this respect within the scope of the invention if

the wall region near the cavity of the mould is exchangeable. An expedient device according to the invention therefore has an exchangeable cavity frame, which with preference is made of steel. This is an inner lining of the hollow space within the mould that is of an exchangeable configuration and separates the mould body and the cavity from one another. The advantages of an exchangeable cavity frame are, in particular, the quick and individual adaptability of the frame to new forms of cavity and the possibility of quick exchangeability. Moreover, it is possible to produce the cavity frame from materials that have an extremely rapid response with regard to changes in temperature. The use of such comparatively expensive materials is then limited to a relatively small proportion by mass or volume in comparison with the body as a whole.

As already stated, the device of the invention is suitable with preference for injection moulding.

A further preferred application area of the device according to the invention is also injection-compression moulding. As a difference from injection moulding, in the case of injection-compression moulding the device additionally has a movable mould core or compression ram. It is of particular interest and preferred in this respect within the scope of the invention that the mould core or compression ram is formed such that it can be controlled separately to a temperature T₃. This variant may be used in particular for the purpose of additionally introducing energy into the material located in the cavity by means of the compression ram, with the consequence that the quality of the resultant molded part can be further increased. In an expedient embodiment, this concept is realized by the mould core or compression ram having a thermoceramic coating.

The invention also relates to a method for producing thick-walled moulded plastics parts with a reduced number of sink marks, or less pronounced sink marks, by injection moulding or injection-compression moulding, in which
a device as hereinabove is provided;
a thermoplastic moulding compound in a flowable state is injected into the mould of the device;
the injected plastics moulding compound is allowed to solidify; and
the solidified plastics moulding compound is demoulded;
   wherein
before and/or during the injection operation, the temperature T₂ of the wall region near the cavity of the mould is brought to and kept at a value greater than the Vicat temperature Tᵥ of the plastics moulding compound, the temperature T₂ being greater than the temperature T₁ of the mould body;
   and
during the solidifying of the plastics moulding compound and before the demoulding, the temperature T₂ of the wall region near the cavity is brought to a temperature below the Vicat temperature Tᵥ of the plastics moulding compound.

According to this procedure, the outer region of the molded part can be controlled to a higher temperature, and if appropriate for longer, with the consequence that the effect of a follow-up pressure or compressing force can be maintained for longer.

The Vicat temperature Tᵥ is understood here as meaning the Vicat softening temperature (VST) according to DIN EN ISO 306 (previously DIN 53460). The Vicat temperature is measured with a needle (with a circular surface area of 1 mm²). This is subjected to a testing force of 10 N (testing force A) or 50 N (testing force B). The test piece with a permissible thickness of 3 to 6.4 mm is exposed to a defined heating rate of 50 or 120 K/h. The VST is reached when the indenter reaches a depth of penetration of 1 mm. By varying the boundary conditions, four combinations of parameters are obtained, to be specific VST/A50, VST/A120, VST/B50 and VST/B120, the VST/B50 method being used for the purposes of the invention unless otherwise indicated.

In principle, in the case of the method of the invention, before and/or during the injection operation, the temperature of the wall region near the cavity, particularly expediently the cavity frame described above, of the mould, is controlled to a higher temperature level by means of suitable heating in comparison with the temperature level of the remaining body of the mould. The temperature control of the outer region near the cavity, preferably the cavity frame, in this case expediently takes place cyclically with respect to the injection-moulding or injection-compression-moulding cycle. During the injection phase, it is also expedient to bring the outer region near the cavity, with preference in the form of the exchangeable cavity frame, to a high temperature level above the Vicat temperature of the injected plastics material, in order to maintain a long follow-up pressure or compressing pressure. After the plastics melt has uniformly solidified, the wall region near the cavity of the mould is brought back to a temperature below the Vicat temperature of the plastics material, to be specific the demoulding temperature, by means of suitable cooling.

As already stated, one advantage of the method according to the invention is that the slow response of the mould with regard to changes in temperature is overcome, and consequently fast cycle times are made achievable in spite of higher temperatures at the moulded part and in spite of a longer follow-up pressure effect or in spite of a longer effect of the compressing force. It is of advantage in this connection if the differences between the temperature level T₂ of the wall region near the cavity and the temperature level T₁ of the remaining mould body are also as great as possible.

Accordingly, a particularly expedient modification of the method according to the invention is distinguished by the fact that a difference Δ_{T21} between the temperature T₂ of the wall region near the cavity and the temperature T₁ of the mould body remote from the cavity of more than 20° C. is set.

An even more preferred variant provides that a difference Δ_{T21} between the temperature T₂ of the wall region near the cavity and the temperature T₁ of the mould body remote from the cavity of more than 40° C. is set.

Such a temperature difference has a particularly advantageous effect on reducing the sink marks of the finished moulded bodies.

In a further favourable modification of the method it is provided that the temperature of the wall region near the cavity of the mould is controlled by means of liquid media, by means of resistance heating or inductively, particularly expediently by means of liquid or gaseous media, such as oil, water or else steam.

The principle of the invention can be applied to the known injection-moulding and injection-compression-moulding processes. Its particularly advantageous effects are obtained, however, in the production of thick-walled moulded bodies from plastic.

The method of the invention is expediently used for producing thick-walled injection-moulded or injection-compression-moulded parts with wall thicknesses of more than 5 mm.

A further advantageous use comprises the production of thick-walled injection-moulded or injection-compression-moulded parts with wall thicknesses of more than 8 mm.

The method of the invention is suitable for producing moulded parts from thermoplastic materials, such as polystyrene, polycarbonate, co-polycarbonate, cyclo-olefin copolymers, polymethylmethacrylic imide, or polyacrylates and methacrylates. A particularly expedient use concerns the production of PMMA moulded parts; most particularly preferred are lenses for optical purposes.

The invention is explained in more detail below on the basis of exemplary embodiments and comparative examples with reference to the accompanying figures, in which:

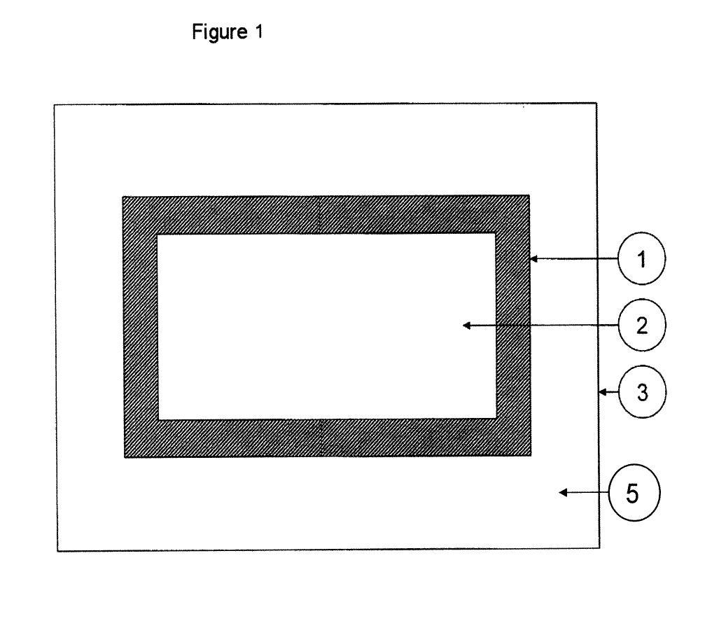

FIG. 1 shows a cross section through an idealized and simplified representation of a mould with a cavity frame;

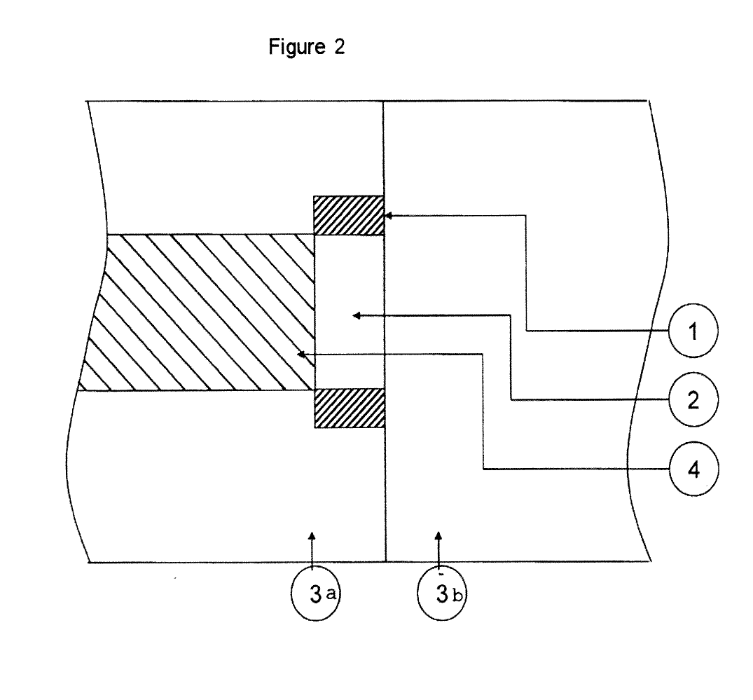

FIG. 2 shows a cross section through a partial view of an embodiment of a device according to the invention;

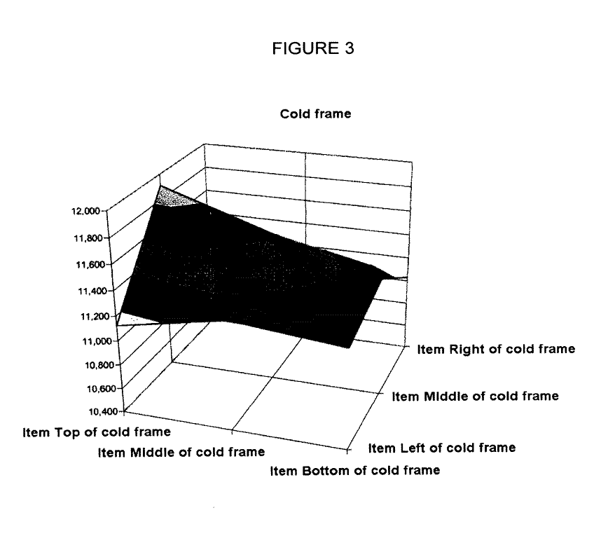

FIG. 3 shows a diagram of the structural thickness distribution with respect to a cold frame; and

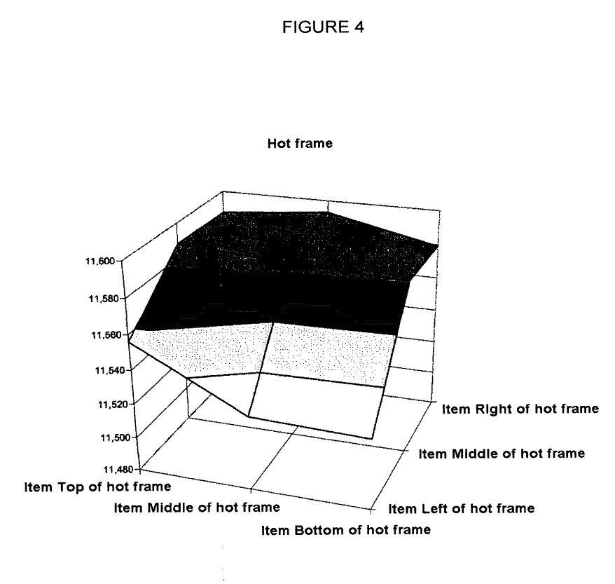

FIG. 4 shows a diagram of the structural thickness distribution with respect to a hot frame.

### LIST OF DESIGNATIONS FOR FIGS. 1 AND 2:

1 Cavity frame
2 Cavity
3 Mould
3a Movable mould side
3b Fixed mould side
4 Compression ram
5 Mould plate

FIG. 1 shows a cross-sectional representation of a basic diagram of a mould. The reference numeral 3 designates a mould for injection moulding. The mould 3 has a hollow space 2 inside it. The hollow space 2 is also referred to as the cavity 2. Also shown is a wall region near the cavity 1 and a body remote from the cavity 5 of the mould. The outer region 1 delimits the hollow space 2. Considered outwards from the hollow space 2, the wall region near the cavity 1 is adjoined by the body remote from the cavity 5 of the mould 3. The wall region near the cavity 1 and the region remote from the cavity or body remote from the cavity 5 of the mould together form the complete body of the mould 3.

FIG. 2 shows as component parts of the mould the plates 3a and 3b. In the case of this two-plate mould, the cavity 2 is integrated in the plate 3a, while the plate 3b can be opened for the demoulding of a finished injection-moulded part.

It can be seen very well that the cavity 2 in the subassembly 3a is surrounded by a kind of frame 1. In the example shown, this cavity frame 1 is of an exchangeable configuration and its temperature can be controlled separately. FIG. 2 also shows the compression ram 4, which can be used for compacting the moulding compound in the cavity.

It goes without saying that the rear wall of the cavity, that is the delimitation of the cavity formed by the subassembly 3b of the mould, may likewise be formed such that its temperature can be controlled separately. However, this is not necessary to achieve the advantageous effects of the invention.

In FIG. 3, the structural thickness distribution with respect to the cold frame is represented. In FIG. 4, the structural thickness distribution with respect to the hot frame is represented.

1. An injection-compression moulding device, comprising a mould comprising:
a cavity;
a wall region; and
a body,
wherein the wall region is near the cavity, adjacent to the cavity, and located laterally in relation to a direction of movement of a mould core or a compression ram, and the body is remote from the cavity and adjacent to the wall region, and
wherein the body may be controlled to a temperature T₁ and the wall region may be controlled to a temperature T₂, wherein the temperature T₂ is different from the temperature T₁.

2. The device of claim 1, wherein the wall region is an exchangeable cavity frame comprising steel.

3. The device of claim 1, wherein the wall region and the body each comprise a separate temperature control circuit.

4. The device of claim 1, wherein a thickness of the wall region is from 1/20 and ¼ of a total thickness of the mould.

5. The device of claim 1, wherein a thickness of the wall region is from 1/10 to ⅕ of a total thickness of the mould.

6. The device of claim 1, further comprising a movable mould core or a compression ram, wherein the mould core or the compression ram may be controlled separately to a temperature T₃.

7. A method for producing a thick-walled moulded plastic part, the method comprising:
injecting a thermoplastic moulding compound, in a flowable state, into the mould of the device of claim 6, to obtain an injected plastic moulding compound;
solidifying the injected plastics moulding compound, to obtain a solidified plastic moulding compound;
demoulding the solidified plastic moulding compound,
wherein before the injecting, during the injecting, or before and during the injecting, the temperature T₂ of the wall region is kept at a value greater than the Vicat temperature Tᵥ of the thermoplastic moulding compound, and the temperature T₂ is greater than the temperature T₁ of the mould body, and
wherein during the solidifying and before the demoulding, the temperature T₂ of the wall region decreased to a temperature below the temperature Tᵥ.

8. The method of claim 7, wherein a difference Δ_{T21} between the temperature T₂ of the wall region and the temperature T₁ of the mould body is more than 20° C.

9. The method of claim 7, wherein a difference Δ_{T21} between the temperature T₂ of the wall region and the temperature T₁ of the mould body is more than 40° C.

10. The method of claim 7, wherein the temperature T₂ of the wall region is controlled by a liquid media, by resistance heating, or inductively.

11. A thick-walled injection-compression-moulded part obtained by the process of claim 7, wherein the moulded part has a wall thickness of more than 5 mm.

12. The moulded part of claim 11, wherein the moulded part has a wall thickness of more than 8 mm.

13. The moulded part of claim 11, wherein the moulded part comprises PMMA.

14. The moulded part of claim 13, wherein the moulded part is an optical lens.

15. The device of claim 1, wherein the device is suitable for producing a thick-walled moulded plastic comprising a reduced number of sink marks or less pronounced sink marks.

16. The process of claim 7, wherein, during the injecting, the thermoplastic moulding compound is PMMA.

17. The device of claim 6, wherein the mould core or compression ram comprises a thermoceramic coating.

18. The device of claim 1, wherein the temperature T₂ of the wall region is controlled by oil.

19. The device of claim 1, wherein the temperature T₂ of the wall region is controlled by water or steam.

20. The process of claim 7, wherein, during the injecting, the thermoplastic moulding compound is at least one selected from the group consisting of polystyrene, polycarbonate, co-polycarbonate, a cyclo-olefin copolymer, polymethylmethacrylic imide, a polyacrylate, and a methacrylate.
